(19) United States
(12) Patent Application Publication
(10) Pub. No.: US 2003/0060228 A1
(43) Pub. Date: Mar. 27, 2003

(54) Presentation services software development system and methods

(76) Inventors: Karen Capers, Castle Rock, CO (US); Laura Wiggett, Colorado Springs, CO (US)

Correspondence Address: Siemens Corporation, Attn: Elsa Keller, Legal Administrator, Intellectual Property Department, 186 Wood Avenue South, Iselin, NJ, 08830, US

(21) Appl. No.: 09/965,475

(22) Filed: Sep. 26, 2001

(51) Int. Cl. H04M 1/00

(52) U.S. Cl. 455/552; 455/426

(57) ABSTRACT

A novel system and method is herein described for creating user interfaces for a plurality of users of an office land mobile network (OLMN), said system and method comprising means and steps for receiving a request from said user for service from said OLMN, said request comprising data pertaining to said service; validating said data received from said request; if said data is valid for said request, formatting said data into an internal format; submitting said formatted request to an appropriate framework for application processing; and returning a user interface, said user interface being appropriate for the particular request received.

### STATEMENT OF RELATED CASES

The following related cases are co-pending, co-owned patent applications—herein incorporated by reference—filed on even date as the present application:

Ser. No. ______ entitled “OBJECT COMMUNICATION SERVICES SOFTWARE DEVELOPMENT SYSTEM AND METHODS” to Karen Capers and Peter Alvin.

Ser. No. _______ entitled “INTEGRATED DIAGNOSTIC CENTER” to Karen Capers and Michael Brooking.

### BACKGROUND OF THE INVENTION

The convergence between legacy PBX, corporate IP Networks, on the one hand, and wireless communications, on the other, is continuing apace. Corporate GSM (or more generally, Office Land Mobile Network, or OLMN) systems that allow a subscribed user to roam onto a corporate wireless subsystem “campus” from the public land mobile network (PLMN) are known in the art.

With newer generations of such OLMNs rolling out, new services are being expected and demanded by the users of such systems. It is typically desirable to have such services—from new communications services to enhancing existing legacy services—seemlessly presented to the user (across the various platforms—PBX, network and wireless—within a given campus). Additionally, it is desirable to have these new services interoperating across various legacy PBX, networks and wireless subsystems—perhaps involving multiple manufacturers, protocols, operating systems and like.

It is additionally desirable to for these services to run robustly. Thus, messages can be delivered to end users even though there may be point failures in the OLMN. Additionally, it may be the case that, for communication systems developers, the location of the components that need to communicate on the network is not static, but changes often. Thus, it is desirable to have a development system that anticipates situations that require a wide variety of communication delivery modes and service. It is also desirable to have a development system that anticipates a wide variety of message formats that may differ in both their semantics and syntax.

In addition to new communications services, it is also desirable to provide a flexible way to create new user interfaces for clients of OLMN, other private networks the Web, as well as command line and platform specific deployments. The extensibility of creating new user interfaces should also provide little or no hardship to administrators of such networks. Thus, any change to user interfaces should ideally have minimal impact on the business logic of the underlying applications.

### SUMMARY OF THE INVENTION

The present invention discloses a novel system and method for creating user interfaces for a plurality of users of an office land mobile network (OLMN), said system and method comprising means and steps for receiving a request from said user for service from said OLMN, said request comprising data pertaining to said service; validating said data received from said request; if said data is valid for said request, formatting said data into an internal format; submitting said formatted request to an appropriate framework for application processing; and returning a user interface, said user interface being appropriate for the particular request received.

### BRIEF DESCRIPTION OF THE DRAWINGS

FIG. 1 is a typical embodiment of an OLMN architecture.

FIG. 2 is a diagram of the structural and functional components of an embodiment made in accordance with the principles of the present invention.

FIG. 3 is use-case diagram of an embodiment of the presentation services framework made in accordance with the principles of the present invention.

### DETAILED DESCRIPTION OF THE INVENTION

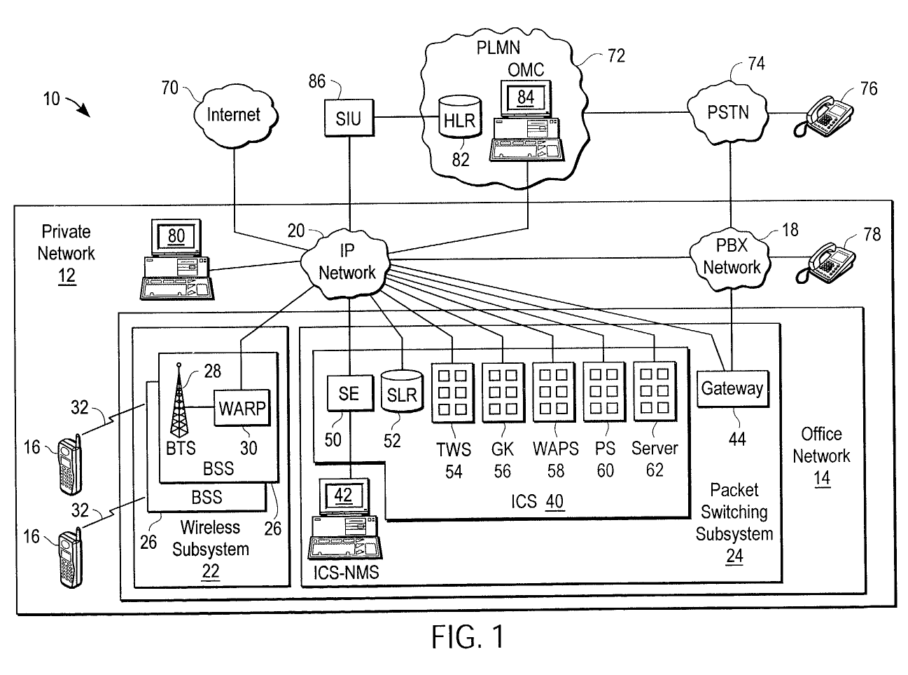

FIG. 1 depicts a typical architecture of an Office Land Mobile Network (e.g. Corporate GSM or “C-GSM”)—illustrating a communication system 10 in accordance with one embodiment of the present invention. The system 10 comprises a private network 12 for providing communication for a plurality of authorized subscribers. According to one embodiment, the private network 12 comprises a communication network for a particular business enterprise and the authorized subscribers comprise business personnel. The private network 12 comprises an office network 14 for providing communication between a plurality of mobile devices 16, a private branch exchange (PBX) network 18, and an Internet Protocol (IP) network 20.

The office network 14 comprises a wireless subsystem 22 for communicating with the mobile devices 16 and a packet switching subsystem 24 for providing operations, administration, maintenance and provisioning (OAMP) functionality for the private network 12. The wireless subsystem 22 comprises one or more base station subsystems (BSS) 26. Each base system subsystem 26 comprises one or more base transceiver stations (BTS), or base stations, 28 and a corresponding wireless adjunct Internet platform (WARP) (alternatively called “IWG”) 30. Each base station 28 is operable to provide communication between the corresponding WARP 30 and mobile devices 16 located in a specified geographical area.

Authorized mobile devices 16 are operable to provide wireless communication within the private network 12 for authorized subscribers. The mobile devices 16 may comprise cellular telephones or other suitable devices capable of providing wireless communication. According to one embodiment, the mobile devices 16 comprise Global System for Mobile communication (GSM) Phase 2 or higher mobile devices 16. Each mobile device 16 is operable to communicate with a base station 28 over a wireless interface 32. The wireless interface 32 may comprise any suitable wireless interface operable to transfer circuit-switched or packet-switched messages between a mobile device 16 and the base station 28. For example, the wireless interface 32 may comprise a GSM/GPRS (GSM/general packet radio service) interface, a GSM/EDGE (GSM/enhanced data rate for GSM evolution) interface, or other suitable interface.

The WARP 30 is operable to provide authorized mobile devices 16 with access to internal and/or external voice and/or data networks by providing voice and/or data messages received from the mobile devices 16 to the IP network 20 and messages received from the IP network 20 to the mobile devices 16. In accordance with one embodiment, the WARP 30 is operable to communicate with the mobile devices 16 through the base station 28 using a circuit-switched protocol and is operable to communicate with the IP network 20 using a packet-switched protocol. For this embodiment, the WARP 30 is operable to perform an interworking function to translate between the circuit-switched and packet-switched protocols. Thus, for example, the WARP 30 may packetize messages from the mobile devices 16 into data packets for transmission to the IP network 20 and may depacketize messages contained in data packets received from the IP network 20 for transmission to the mobile devices 16.

The packet switching subsystem 24 comprises an integrated communication server (ICS) 40, a network management station (NMS) 42, and a PBX gateway (GW) 44. The ICS 40 is operable to integrate a plurality of network elements such that an operator may perform OAMP functions for each of the network elements through the ICS 40. Thus, for example, an operator may perform OAMP functions for the packet switching subsystem 24 through a single interface for the ICS 40 displayed at the NMS 42.

The ICS 40 comprises a plurality of network elements. These network elements may comprise a service engine 50 for providing data services to subscribers and for providing an integrated OAMP interface for an operator, a subscriber location register (SLR) 52 for providing subscriber management functions for the office network 14, a teleworking server (TWS) 54 for providing PBX features through Hicom Feature Access interfacing and functionality, a gatekeeper 56 for coordinating call control functionality, a wireless application protocol server (WAPS) 58 for receiving and transmitting data for WAP subscribers, a push server (PS) 60 for providing server-initiated, or push, transaction functionality for the mobile devices 16, and/or any other suitable server 62.

Each of the network elements 50, 52, 54, 56, 58, 60 and 62 may comprise logic encoded in media. The logic comprises functional instructions for carrying out program tasks. The media comprises computer disks or other computer-readable media, application-specific integrated circuits (ASICs), field-programmable gate arrays (FPGAs), digital signal processors (DSPs), other suitable specific or general purpose processors, transmission media or other suitable media in which logic may be encoded and utilized. As described in more detail below, the ICS 40 may comprise one or more of the servers 54, 58, 60 and 62 based on the types of services to be provided by the office network 14 to subscribers as selected by an operator through the NMS 42.

The gateway 44 is operable to transfer messages between the PBX network 18 and the IP network 20. According to one embodiment, the gateway 44 is operable to communicate with the PBX network 18 using a circuit-switched protocol and with the IP network 20 using a packet-switched protocol. For this embodiment, the gateway 44 is operable to perform an interworking function to translate between the circuit-switched and packet-switched protocols. Thus, for example, the gateway 44 may packetize messages into data packets for transmission to the IP network 20 and may depacketize messages contained in data packets received from the IP network 20.

The communication system 10 may also comprise the Internet 70, a public land mobile network (PLMN) 72, and a public switched telephone network (PSTN) 74. The PLMN 72 is operable to provide communication for mobile devices 16, and the PSTN 74 is operable to provide communication for telephony devices 76, such as standard telephones, clients and computers using modems or digital subscriber line connections. The IP network 20 may be coupled to the Internet 70 and to the PLMN 72 to provide communication between the private network 12 and both the Internet 70 and the PLMN 72. The PSTN 74 may be coupled to the PLMN 72 and to the PBX network 18. Thus, the private network 12 may communicate with the PSTN 74 through the PBX network 18 and/or through the IP network 20 via the PLMN 72.

The PBX network 18 is operable to process circuit-switched messages for the private network 12. The PBX network 18 is coupled to the IP network 20, the packet switching subsystem 24, the PSTN 74, and one or more PBX telephones 78. The PBX network 18 may comprise any suitable network operable to transmit and receive circuit-switched messages. In accordance with one embodiment, the gateway 44 and the gatekeeper 56 may perform the functions of a PBX network 18. For this embodiment, the private network 12 may not comprise a separate PBX network 18.

The IP network 20 is operable to transmit and receive data packets to and from network addresses in the IP network 20. The IP network 20 may comprise a local area network, a wide area network, or any other suitable packet-switched network. In addition to the PBX network 18, the Internet 70 and the PLMN 72, the IP network 20 is coupled to the wireless subsystem 22 and to the packet switching subsystem 24.

The IP network 20 may also be coupled to an external data source 80, either directly or through any other suitable network such as the Internet 70. The external data source 80 is operable to transmit and receive data to and from the IP network 20. The external data source 80 may comprise one or more workstations or other suitable devices that are operable to execute one or more external data applications, such as MICROSOFT EXCHANGE, LOTUS NOTES, or any other suitable external data application. The external data source 80 may also comprise one or more databases, such as a corporate database for the business enterprise, that are operable to store external data in any suitable format. The external data source 80 is external in that the data communicated between the IP network 20 and the external data source 80 is in a format other than an internal format that is processable by the ICS 40.

The PLMN 72 comprises a home location register (HLR) 82 and an operations and maintenance center (OMC) 84. The HLR 82 is operable to coordinate location management, authentication, service management, subscriber management, and any other suitable functions for the PLMN 72. The HLR 82 is also operable to coordinate location management for mobile devices 16 roaming between the private network 12 and the PLMN 72. The OMC 84 is operable to provide management functions for the WARPs 30. The HLR 82 may be coupled to the IP network 20 through an SS7-IP interworking unit (SIU) 86. The SIU 86 interfaces with the WARPs 30 through the IP network 20 and with the PLMN 72 via a mobility-signaling link.

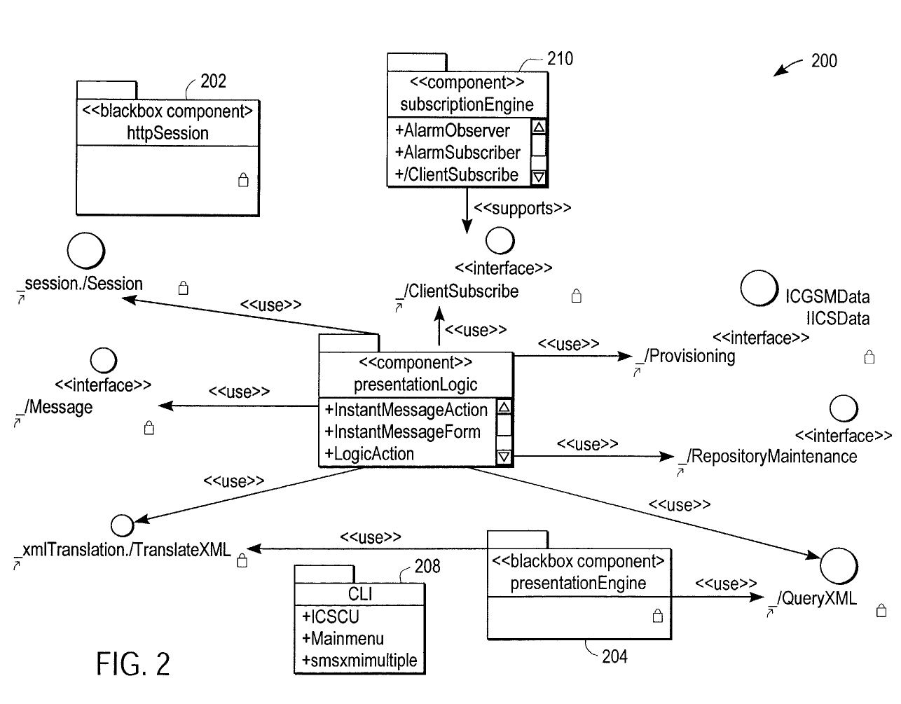

FIG. 2 is a diagram of the structural and functional components of one embodiment of a system made in accordance with the principles of the present invention.

Structural Components

Presentation Services System (or Framework) 200 comprises several components as depicted and is responsible for the web-based user interface into the ICS system. It provides the interfaces for user operations and validates basic user-input data. It further sends user-input data to other frameworks for application specific processing and displays the returned results to the user. System 200 also performs HTTP session management. A user's session will be established by the session framework and used by the Presentation Services System for displaying a user's view of the system, based on the user's role. Features available include subscriber provisioning, profile management, instant messaging and OAMP.

HttpSession component 202 will provide browser session handling. This component could be provided by the third-party product used to implement the presentationEngine component 204.

The interface to httpSession component 202 is as follows:

public interface ImanageHttpSession

IManageHttpSession is supported by the httpSession component. It provides access to HTTP session handling.

The presentation Engine component 204 will provide user interface displays for web-based ICS system access. Elements of the presentationLogic component 206 will run on this engine. These elements could include, but are not limited to, applets, JSPs, servlets, etc. PresentationEngine component 204 provides the functionality of a web server, a servlet engine and/or an application server, and could be supplied by known off-the-shelf products. It will provide HTTP and/or HTTPS access to the client browser.

The interface of presentationEngine component 204 is as follows:

public interface IHttp

This interface serves as a logical entry point for all ICS system web-based access (e.g. HTTP access).

The presentationLogic component 206 contains the library of classes to support the business logic and application processing necessary for this system or framework to do its job. This could include applets, servlets, JavaBeans or any other collection of classes needed to process and perform simple validation of data. This component supports the IServiceRequest interface.

The presentationLogic component 206 comprises two Class Nodes:

com.opuswave.ics.serviceEngine.presentationServices.presentationLogic.LoginAction

com.opuswave.ics.serviceEngine.presentationServices.presentationLogic.LoginForm

The class node “LogicAction” is described by:

public class LoginAction

Extends:

org.apache.struts.action.Action

This Action bean will perform the login handling.

Operation Detail

authenticateUser

public String authenticateUser(String userid, String password)

This method is pulled out of the perform method in order for the CLI 208 to use this class.

perform

public ActionForward perform(ActionMapping mapping, ActionForm form, HttpServletRequest request, HttpServletResponse response)

This method is called on by ActionServlet when a request is made for login action. “mapping” is a class representation of our logon action as defined in action.xml. “form” is our form bean that we created for this action, it should be an instance of “LoginForm”.

The class node “LoginForm” is described by:

public class LoginForm

Extends:

org.apache.struts.action.ActionForm

The LoginForm will perform data gathering and validation of login information.

Attribute Detail

password

private String password

userid

private String userid

Operation Detail

getPassword

public String getpassword( )

getuserid

public String getuserid( )

setPassword

public void setPassword(String password)

setUserid

public void setUserid(String userid)

validate

public ActionErrors validate(ActionMapping mapping, HttpServletRequest request)

Interface Detail

Interface

public interface IServiceRequest

This interface allows the presentationEngine component 204 to pass service requests to the presentationLogic component 206 for validation and application processing.

The subscriptionEngine component 210 provides access to the event component in the Object Communication Services framework. This allows clients to subscribe to real-time data such as alarms and event notifications. This component supports the interface IClientSubscribe.

Class Nodes

com.opuswave.ics.serviceEngine.presentationServices.subscriptionEngine.AlarmObserver

com.opuswave.ics.serviceEngine.presentationServices.subscriptionEngine.AlarmSubscriber

Interface Nodes

com.opuswave.ics.serviceEngine.presentationServices.subscriptionEngine.IClientSubscribe

com.opuswave.ics.serviceEngine.presentationServices.subscriptionEngine.Observer

Class Detail

AlarmObserver Class

public class AlarmObserver

Implements:

com.opuswave.ics.serviceEngine.presentationServices.subscriptionEngine.Observer

The AlarmObserver class implements the abstract interface Observer as described in the GoF Observer pattern. The AlarmObserver plays the role of the ConcreteObserver. The AlarmObserver's update( ) method will be called when an alarm is generated by the OAMPManager.

Operation Detail

update

public void update( )

Class

com.opuswave.ics.serviceEngine.presentationServices.subscriptionEngine.AlarmSubscriber

public class AlarmSubscriber

Implements:

com.opuswave.ics.serviceEngine.presentationServices.subscriptionEngine.IClientSubscribe

This is the class for the client subscribers. Each instance will be notified by their notify( ) method when an alarm meeting their request is received by the subscription engine. This class implements the IClientSubscribe interface.

Interface Detail

Interface

com.opuswave.ics.serviceEngine.presentationServices.subscriptionEngine.IClientSubscribe

public interface IClientSubscribe

This interface allows the presentationLogic component to subscribe and receive events through the subscriptionEngine component.

Class

com.opuswave.ics.serviceEngine.presentationServices.subscriptionEngine.Observer

Interface

com.opuswave.ics.serviceEngine.presentationServices.subscriptionEngine.Observer

public interface Observer

This is the interface as presented in the GoF Observer pattern.

Operation Detail

update

public abstract void update( )

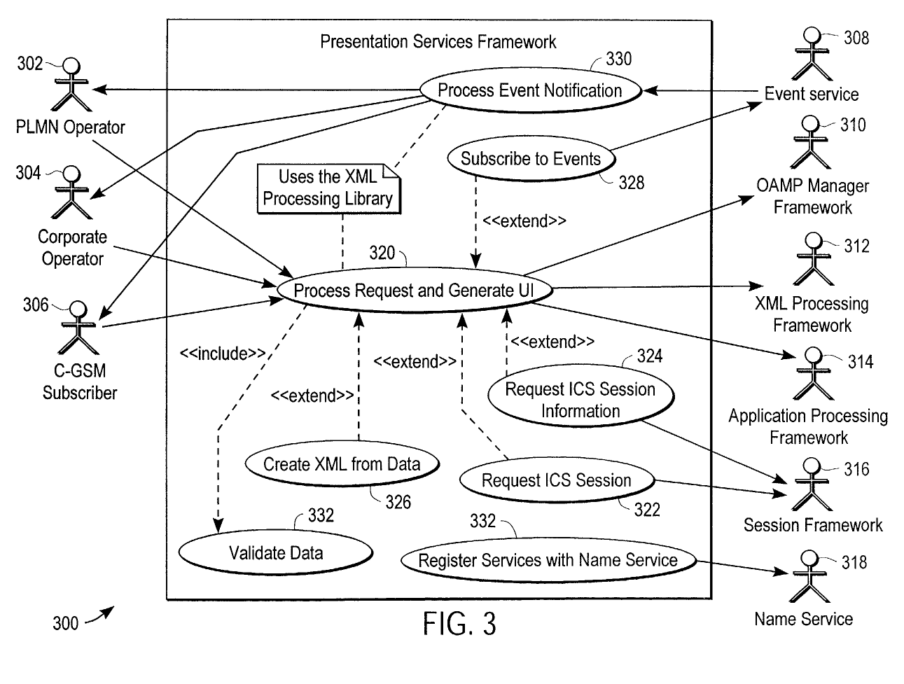

FIG. 3 is a diagram of a use-case description in UML of one embodiment of the presently claimed system. The Presentation Services Framework 300 provides web access to the ICS system. All web-based user requests to the ICS system will enter through the Presentation Services Framework. These requests will be sent to the correct framework for further processing and the results will be displayed to the user.

In what follows in the use-case description, system actors are shown vis-à-vis process objects and their pre-conditions, flow of events—including one or more scenarios—are given. It will be appreciated that the flow of events represents a flowchart of events and processing for the various process objects.

System Use Case—Process Request And Generate UI

The Presentation Services Framework 300 generates a user interface based on a request from a user (e.g. PLMN Operator 302, Corporate Operator 304, C-GSM Subscriber 306 and the like). This interface could be an HTML page, an applet, or any another form of user interface. When the UI is displayed, the user could have several options to choose from. Based on the option selected, the Presentation Services Framework 300 processes the request, send requests to other frameworks when required, and display the results to the user. Input data could be validated (332) and may be formatted for certain scenarios of this use case.

System Actors

Primary: PLMN Operator 302

Primary: Corporate Operator 304

Primary: C-GSM Subscriber 306

Secondary: OAMP Manager Framework 310

Secondary: Application Processing Framework 314

Secondary: XML Processing Framework 312

Pre-conditions

The user navigates to the interface that provides access to the ICS feature they wish to use.

Flow of Events

Scenario: Basic Flow

1. The user shall enter appropriate data and submit the request.

2. The system shall collect the data from the request.

3. The “Validate data” use case will be executed.

4. If the previous step is successful, the data may be formatted into an XML string or some other suitable structure.

5. If the previous step is not successful, an error screen shall be displayed and the user will have the option of correcting the error, and steps 2-4 will be executed again.

6. The request data shall be submitted to the appropriate framework for application processing.

7. The results of the request shall be returned to the system, and an appropriate screen will be displayed. This screen may be a success message, a request for further information or an error condition.

Scenario: Provide user interfaces for Operations, Administration, Maintenance and Provisioning (OAMP)

The following scenario describes the features of OAMP for ICS and the list of user interface required based upon the requirements of the ICS system:

Configuration Management and State Management

This deals with the collection of data to perform system provisioning and configuration operations for a subsystem. This includes the presentation of user interfaces for the creation, deletion, modification and viewing of subsystem managed object provisioning and configuration data.

Add Subsystem (Network Element)

Remove Subsystem (Network Element)

Modify Subsystem Network Element)

View Subsystem (Network Element)

Shutdown Subsystem (Network Element)

Software Management

This deals with the collection of data to perform software configuration and management operations for a subsystem. This includes the presentation of user interfaces for specifying the target subsystem of the software upload, download or activation operation, the software component to be uploaded, downloaded, or activated.

Download Software

Upload Software

Activate Software

Activate Software (Network Element)

Deactivate Software (Network Element)

Fault Management

This deals with the collection of data to view and manage system alarms. This includes the presentation of user interfaces for setting the filters for alarms to be viewed.

Display List of Alarms

View Alarm

Filter Alarms

Clear Alarm

Acknowledge Alarm

Terminate Alarm

Scenario: Provide User Interfaces for Subscriber Provisioning

The following scenario describes the features of subscriber provisioning for ICS and the list of user interface required based upon the requirements of the ICS system:

Subscriber Database Management

This deals with the collection of data to perform operations on the subscriber database. The subscriber database could be comprised of several different data sources (an ICS repository, the SLR, TWS, etc.), but to this system it might appear as a single data source. All intelligence for data routing and type and location of physical storage could be provided by other frameworks within the Service Engine. Subscriber database management includes the presentation of user interfaces for creation, deletion, backup, restoration, upload, download and bulk upload of the subscriber database.

Create Subscriber Database

Delete Subscriber Database

Backup Subscriber Database

Schedule Subscriber Database Backup

Restore Subscriber Database

Upload Subscriber Database

Download Subscriber Database

Bulk Upload Data to Subscriber Database

C-GSM Subscriber Provisioning

This deals with the collection of data to perform provisioning and configuration operations for a C-GSM Subscriber. This includes C-GSM Subscriber profile information. C-GSM Subscriber provisioning includes the presentation of user interfaces for adding, deleting, modifying, viewing and activation of subscriber provisioning and configuration data.

Add New Subscriber

Modify Subscriber

View Subscriber

Delete Subscriber

Activate Subscriber

ICS Profile Management

This deals with the collection of data to perform ICS profile operations for a C-GSM Subscriber. This includes the presentation of user interfaces for managing message & email alert filters and changing passwords.

Manage Message Notification Filters

Manage E-mail Notification Filters

Change Password

Scenario: Provide Instant Messaging User Interface

The system requests the Application Processing Framework 314 to provide a list of valid C-GSM subscribers for the user to select from. The Application Processing Framework 314 also provides a list of ‘groups’, a user's pre-defined subset of C-GSM Subscribers.

The system shall present an ICS instant message-editing screen with the list of valid C-GSM Subscribers and the user's groups. When the request has been submitted, the system shall collect the message text and the entries from the ‘to’ list and submit the request to the Application Processing Framework 314. The system shall present a screen displaying a “message submitted” message to the user, or if the Application Processing Framework is unavailable, the system shall present a screen displaying an error message.

Post-conditions

The system requested an action be performed based on the user's request and has displayed a screen with the result of the user's request.

Related Use Cases

Include: Validate data 332

Extend: Create XML from data 326

Extend: Request ICS session 322

Extend: Request ICS session information 324

Extend: Subscribe to events 328

System Use Case: Validate Data

The Presentation Services Framework provides basic data validation. This might include field type checking (such as phone number formatting, numeric fields, etc.). Application data validation, such as range checking and text field value checking, could be done in other frameworks.

Related Use Cases

Included by: Process request and generate UI 320

System Use Case: Request ICS Session

When a user logs into the ICS system using a web browser, they require an ICS session. The Session Framework provides this ICS session. The reference to this session could be requested and stored in the Presentation Services Framework.

System Actors

Primary: C-GSM Subscriber 306

Primary: PLMN Operator 302

Primary: Corporate Operator 304

Secondary: Session Framework 316

Pre-conditions

The user has submitted the initial userid/password combination to login to the ICS system.

Flow of Events

Scenario: Basic flow

1. The system reads in the userid and password from the login request.

2. A request for an ICS Session is sent to the Session Framework with the userid and password.

3. If the request is successful (the userid/password combination is valid), the Session Framework returns a reference to the ICS session which will be saved in the HTTP session.

4. If the request returns null, an error screen is generated to provide the user the option to either retype their userid/password combination or a link to an initial profile setup.

Post-conditions

The user has logged into the ICS system, or has been presented an option to create a login profile.

Related Use Cases

Extends: Process request and generate UI 320

System Use Case: Request ICS Session Information

Once a user has logged on to the ICS system, an ICS session object is created and a reference to it is stored in the Presentation Services Framework. This reference can then be used to access role and privilege information about the user, as well as information about the session itself.

System Actors

Primary: C-GSM Subscriber 306

Primary: PLMN Operator 302

Primary: Corporate Operator 304

Secondary: Session Framework 316

System Objects

Pre-conditions

The user has logged into the ICS system and a valid ICS session exists for this user.

Flow of Events

Scenario: Basic flow

1. A request is sent to the Session Framework for the information about the session (such as role, timeout information, etc.).

2. This information is returned to the Presentation Services Framework for use in processing requests.

Post-conditions

The Presentation Services Framework has the requested information.

Related Use Cases

Extends: Process request and generate UI 320

System Use Case: Create XML From Input Data

The data collected from the user interface is converted into an XML format before it is sent to another framework for processing. The Presentation Services Framework can do this conversion based on an agreed-upon XML format (such as an XML DTD or schema or the like).

Related Use Cases

Extends: Process request and generate UI 320

System Use Case: Subscribe To Events

In order for events to be displayed to the user, the web-based UI requests a subscription to events of interest.

System Actors

Primary: C-GSM Subscriber 306

Primary: PLMN Operator 302

Primary: Corporate Operator 304

Secondary: Event Service 308

Pre-conditions

The Event Service is available for subscriptions.

A user has submitted a request to receive notifications of events.

Flow of Events

Scenario: Basic Flow

1. The system subscribes to the channel of the Event Service that is publishing the events of interest.

Post-conditions

The web-based UIs interested in certain events have been registered to receive event notifications.

Related Use Cases

Extends: Process request and generate UI 320

System Use Case: Register Services With Name Service

At system start-up, or any time after the Presentation Services Framework or one of its services has been unavailable, the Presentation Services Framework's services shall be registered with the name service.

System Use Case: Process Event Notification

When an event is published by the Event Service that is of the type the Presentation Services Framework has subscribed to, the notification is received by the Presentation Services Framework and is distributed to the interested web-based UIs for display to the user.

System Actors

Primary: Event Service

Secondary: PLMN Operator

Secondary: Corporate Operator

Pre-conditions

The “Subscribe to events” use case has been successfully executed for the event type of interest.

An event has been generated by the system and has been published by the Event Service.

Flow of Events

Scenario: Basic Flow

1. The system receives the event notification.

2. The system delivers this notification to every web-based UI that has requested this form of notification.

Post-conditions

The web-based UIs interested in a type of event have received the notification.

It has now been described a novel system and method for the creation of new user interfaces for an integrated communications server on a private network. It will be appreciated that the foregoing description of several embodiments are illustrative of the principles of the present invention and that the scope of the present invention should not be limited to the recitation of such embodiments. Additionally, the scope of the present invention contemplates all obvious extensions of the foregoing embodiments.

1. In an office land mobile network (OLMN) system, a method for creating user interfaces for a plurality of users of said OLMN, the steps of said method comprising:
receiving a request from said user for service from said OLMN, said request comprising data pertaining to said service;
validating said data received from said request;
if said data is valid for said request, formatting said data into an internal format;
submitting said formatted request to an appropriate framework for application processing; and
returning a user interface, said user interface being appropriate for the particular request received.

2. The method as recited in claim 1 wherein one of said plurality of users making service requests is a PLMN operator.

3. The method as recited in claim 1 wherein one of said plurality of users making service requests is a corporate operator.

4. The method as recited in claim 1 wherein one of said plurality of users making service requests is a OLMN subscriber.

5. The method as recited in claim 1 wherein said internal format comprises extensible markup language.

6. The method as recited in claim 1 wherein said request is made for OAMP services; and
further wherein said data pertains to system provisioning for a subsystem of said OLMN.

7. The method as recited in claim 6 wherein said step of returning a user interface further comprises returning a user interface appropriate for operations upon subsystem managed objects.

8. The method as recited in claim 7 wherein said operations comprises a group, said group further comprising one of creation, deletion, modification and viewing said objects.

9. The method as recited in claim 6 wherein said system provisioning data comprises data for software configuration for a subsystem.

10. The method as recited in claim 9 wherein said data for software configuration further comprises data for one of a group, said group further comprising download, upload, activate, and deactivate software.

11. The method as recited in claim 6 wherein said system provisioning data comprises data for subscriber provisioning.

12. The method as recited in claim 11 wherein said data for subscriber provisioning further comprises data for one of a group, said group further comprising create, delete, backup, schedule, restore, upload, download, and bulk upload subscriber database.

13. The method as recited in claim 11 wherein said subscriber provisioning data comprises further comprises data for one of a group, said group further comprising add, modify, view, delete, and activate subscriber.

14. The method as recited in claim 1 further comprising the steps:
requesting a list of valid subscribers;
presenting an instant messaging screen comprising said list of valid subscribers to said user;
collecting message text and subscriber selection from said user;
submitting said instant message request to an appropriate framework.

15. The method as recited in claim 1 wherein the step of receiving a request from a user further comprises:
receiving a request to logon to said OLMN system;
sending said request to logon to an appropriate framework; and
if said logon request is valid, return a reference to new session for said user.

16. The method as recited in claim 1 further comprising:
subscribing to one or more events;
displaying to said user said one or more event; and
delivering to said user notification of said one or more events.

17. A OLMN system comprising:
one or more subscribed users of said system;
an integrated communications server; wherein said users submit requests for services;
a presentation services framework, said framework receiving said requests from said users; formatting said requests from users; forwarding said requests to appropriate frameworks for further processing; and presenting an appropriate user interface to said user.

18. The OLMN system as recited in claim 17 wherein said one of more subscribed user comprises a PLMN operator.

19. The OLMN system as recited in claim 17 wherein said one of more subscribed user comprises a corporate operator.

20. The OLMN system as recited in claim 17 wherein said one of more subscribed user comprises a OLMN subscriber.

21. A system for creating user interfaces for a plurality of users of an OLMN, comprising:
a computer-processable medium; and
logic stored on the computer-processable medium, the logic operable to receive a request from said user for service from said OLMN, said request comprising data pertaining to said service; to validate said data received from said request; if said data is valid for said request, to format said data into an internal format; to submit said formatted request to an appropriate framework for application processing; and to return a user interface, said user interface being appropriate for the particular request received.
